(19) United States
(12) Patent Application Publication
(10) Pub. No.: US 2014/0205025 A1
(43) Pub. Date: Jul. 24, 2014

(54) ADAPTIVE FILTER APPLICATION TO VIDEO DATA

(71) Applicant: MICROSOFT CORPORATION, Redmond, WA (US)

(72) Inventors: Stacey Spears, Sammamish, WA (US); Haoyun Wu, Sammamish, WA (US); Rui Wu, Bellevue, WA (US); Sudhakar Prabhu, Bellevue, WA (US)

(73) Assignee: Microsoft Corporation, Redmond, WA (US)

(21) Appl. No.: 13/747,203

(22) Filed: Jan. 22, 2013

(51) Int. Cl. H04N 7/26

(52) U.S. Cl. CPC H04N 19/00909
USPC 375/240.29

(57) ABSTRACT

A method for correcting artifacts in compressed video having interlaced frames may comprise receiving decoded video data, the decoded video data including a frame and metadata corresponding to the frame. The method may further comprise applying a vertical chroma filter to the frame responsive to determining that the metadata indicates that the frame is an interlaced frame.

### BACKGROUND

Video content may be compressed using progressive and/or interlaced subsampling on each frame of the video content. During some stages of video content compression and distribution, each frame of video content may be associated with metadata identifying whether the frame is progressive or interlaced. Further, some compressed video content using interlaced subsampling exhibits a visual artifact when the video data is displayed on a display device.

### SUMMARY

Embodiments are disclosed herein for providing a method of correcting artifacts in compressed video having interlaced frames. For example, a computing device may receive decoded video data, the decoded video data including a frame and metadata corresponding to the frame. In order to correct visual artifacts that may occur in some interlaced frames, the method may further comprise applying a vertical chroma filter to the frame. By performing such application responsive to determining that the metadata indicates that the frame is an interlaced frame, the method may ensure that the filter is applied to every interlaced frame and is not applied to any progressive frame.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a non-limiting example of an environment including a computing system and a display device in accordance with an embodiment of the present disclosure.

FIG. 2 shows an example method of selectively applying a filter to a frame of video data in accordance with an embodiment of the present disclosure.

FIG. 3 shows an example block diagram of a computing device for processing video data in accordance with an embodiment of the present disclosure.

FIG. 4 is an example computing system in accordance with an embodiment of the present disclosure.

### DETAILED DESCRIPTION

The present disclosure is directed to selective and adaptive application of a filter to interlaced frames of video data. As described in the background presented above, some video data exhibits visual artifacts when displayed on a display device. For example, compressed video data having frames using 4:2:0 interlaced subsampling may exhibit an interlaced chroma problem in which spurious detail is displayed along edges of strong color. The issue may arise when utilizing MPEG-2, VC-1, and/or H264 encoding standards, for example. However the methods described herein may be applied to any suitable encoding standards that exhibit visual artifacts in interlaced frames.

Some computing devices correct for the interlaced chroma problem by detecting the visual artifact and applying a filter responsive to such detection. However, detection mechanisms may not be sufficiently accurate to detect the presence of each visual artifact that occurs. Further, the analysis for detecting the artifact may use data from multiple frames, resulting in improperly timed application of the filter. For example, the filter may be applied after the visual artifact has been displayed for a period of time, and/or may persist during particular frames (e.g., progressive frames) that do not exhibit the visual artifact during associated display of the frames. Furthermore, it may be computationally expensive to detect the visual artifact in the video data.

The methods and systems of the present disclosure correct for the interlaced chroma problem by preserving metadata associated with frames of video data throughout video processing. More particularly, a progressive_frame flag, indicating whether a frame is progressive or interlaced, may be passed from a decoder to a video quality functionality block in a graphics processing unit of a computing device. By applying a filter for each frame that is determined to be interlaced based on the metadata, the filter may be adaptively applied on a per-frame basis to correct (e.g., reduce, hide, remove, etc.) each visual artifact without over-correcting non-interlaced frames.

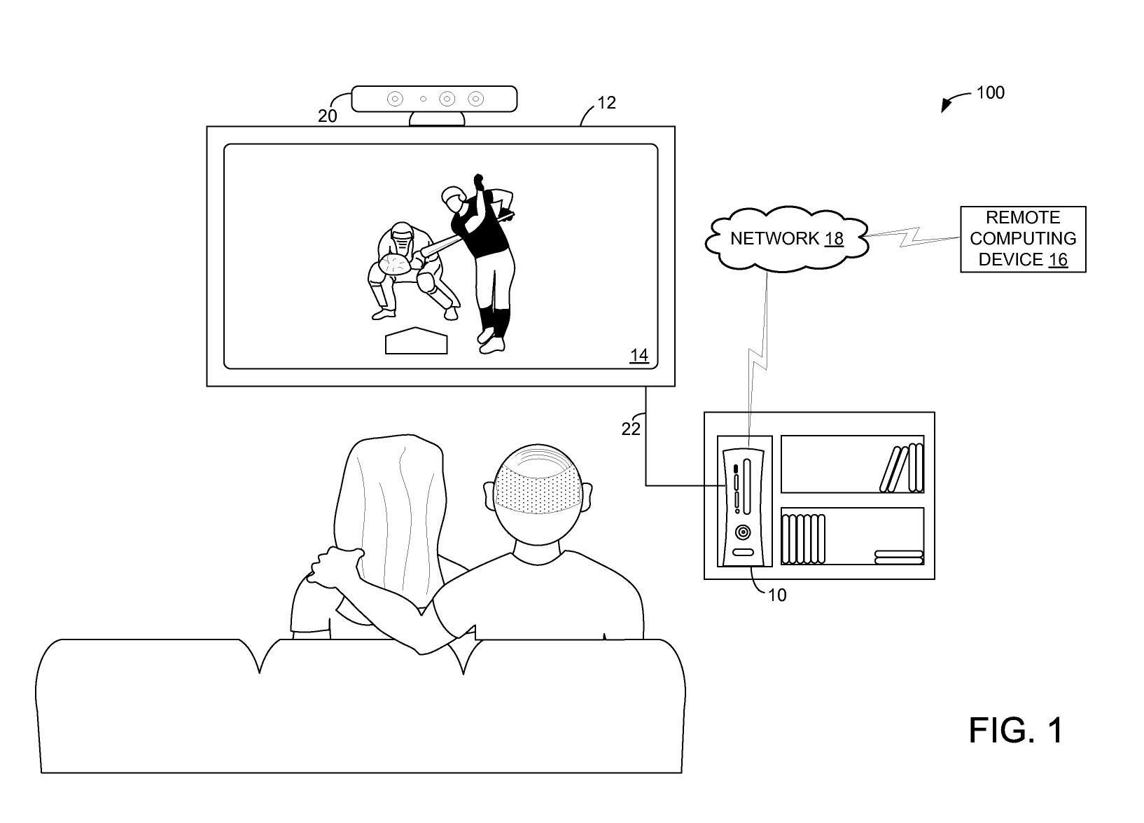

FIG. 1 shows an example environment 100 including a computing device 10 communicatively connected to a display device 12. Computing device 10 may be configured to receive and/or process video data from any suitable source for display on a display 14 of display device 12. For example, computing device 10 may receive video data from one or more removable media and/or built-in devices, such as optical memory devices, (e.g., CD, DVD, HD-DVD, Blu-ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Further, computing device 10 may receive video data from remote computing devices 16 over a network 18. In some embodiments, computing device 10 may receive streaming video data from an external device, such as camera 20. Computing device 10 may communicate with video data sources, such as remote computing device 16 and camera 20, via any suitable wireless or wired communication protocol. For example, computing device 10 may communicate with video data sources via WiFi, WiFi direct, Bluetooth, data cabling (USB, Ethernet, IEEE 1394, eSATA, etc.), and/or any suitable communication mechanism.

Upon receiving video data from one or more video data sources, computing device 10 may be configured to process the video data for display on display device 12. For example, the video data may be encoded upon receipt; therefore computing device 10 may decode the video data and render it for display. After processing the received video data, computing device 10 may output a signal representing the processed video data to display device 12 over communication line 22. Communication line 22 may utilize any suitable wired or wireless communication protocol and/or hardware. For example, communication line 22 may comprise one or more video data cable connectors (e.g., HDMI, DVI, VGA, RCA, component video, S-video, etc.) for sending video data from computing device 10 to display device 12. The display device 12 may receive the video data and display one or more frames of the video data on display 14.

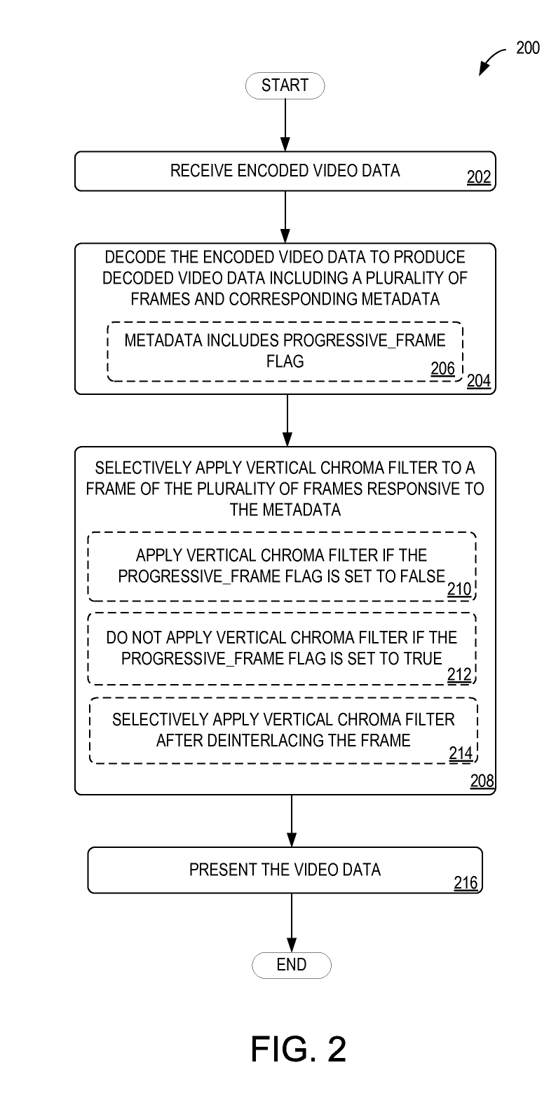

FIG. 2 shows an example method 200 of selectively and adaptively applying a filter to a frame of video data in accordance with an embodiment of the present disclosure. Method 200 may be performed on any suitable computing device for processing video data for display on a display device. Method 200 includes receiving encoded video data at 202.

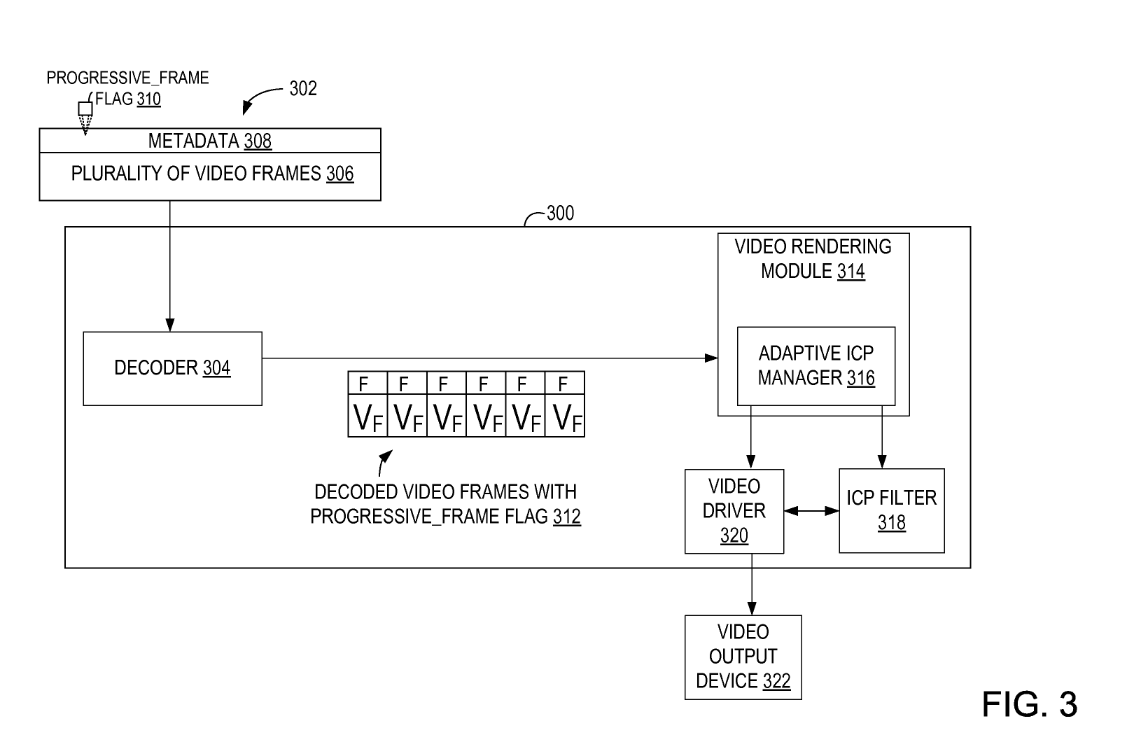

Turning briefly to FIG. 3, a block diagram of an example computing device 300 for processing video data from one or more video data sources is illustrated. For example, computing device 300 may correspond to computing device 10 of FIG. 1 and/or may perform the method described in FIG. 2. Although computing device 300 is shown as including particular modules and devices, computing device 300 may include additional and/or alternative modules. For example, encoded video data 302 may originate from a video data source within the computing device 300 in some embodiments.

As illustrated, computing device 300 may include decoder 304 for receiving encoded video data 302. The encoded video data 302 may take on any suitable form and/or format, including but not limited to a bitstream or stream of video content. The encoded video data 302 may include a plurality of video frames 306 and metadata 308 associated with or otherwise corresponding to the plurality of video frames 306. For example, metadata 308 may include a progressive_frame flag 310 for each video frame in the plurality of video frames 306. The progressive_frame flag 310 may be set to true when a corresponding video frame is a progressive frame and false when a corresponding video frame is an interlaced frame.

Turning back to FIG. 2, method 200 includes decoding the encoded video data to produce decoded video data including a plurality of frames and corresponding metadata at 204. The metadata may include information indicating whether a particular frame is an interlaced or a progressive frame. As indicated at 206, the metadata may optionally include a progressive_frame flag indicating the above-described properties of the frame. Turning briefly to FIG. 3 again, decoder 304 is illustrated, and may be configured to decode video data that is encoded via any suitable encoding method, including but not limited to MPEG-2, VC-1, and/or H264 standards. For example, decoder 304 may be configured to decode video data that is encoded using 4:2:0 chroma subsampling in accordance with one of the above-identified standards. Upon decoding encoded video data 302, decoder 304 may send decoded video frames 312 along with each corresponding progressive_frame flag to a video rendering module 314. In some embodiments, decoded video data may include the decoded video frames and at least a portion of the metadata 308 corresponding to each frame of the plurality of video frames 306. Accordingly, a correspondence between the plurality of progressive_frame flags and the plurality of video frames may be maintained in the decoded video data. Specifically, each progressive_frame flag may set to true when a corresponding video frame is a progressive_frame and false when a corresponding video frame is an interlaced frame.

Returning to FIG. 2, method 200 includes selectively applying a vertical chroma filter to a frame of the plurality of frames responsive to the metadata, as indicated at 208. For example, if the metadata includes a progressive_frame flag, the computing device may apply the selective vertical chroma filter if the progressive_frame flag is set to false, as indicated at 210. Conversely, the computing device may not apply the selective vertical chroma filter if the progressive_frame flag is set to true, as indicated at 212. In additional or alternative embodiments, the computing device may apply the vertical chroma filter based on one or more detection algorithms. For example, a source device may not offer progressive output. Therefore, all frames from such a source device may be consumed by a receiving device as interlaced frames, regardless of the original encoding and/or progressive_frame flag settings of the frames. The detection algorithms may detect a visual artifact in a frame and/or any other indication that the frame may exhibit such a visual artifact.

As indicated at 214, method 200 may include selectively applying the selective vertical chroma filter after deinterlacing the frame. For example, the computing device may determine that a frame is an interlaced frame, perform the deinterlacing processing on the frame, then apply the selective vertical chroma filter. Furthermore, in some embodiments, the video may be converted before applying the selective vertical chroma filter. For example, a frame using 4:2:0 interlaced subsampling may be converted to use 4:2:2 or 4:4:4 interlaced subsampling before applying the selective vertical chroma filter. Such conversion may be performed to ensure that the vertical chroma resolution is the same as luma resolution before applying the filter.

Turning back to FIG. 3, the video rendering module 314 may include an adaptive interlaced chroma problem (ICP) manager 316 for managing the selective application of a filter to one or more of the decoded video frames 312. In particular, the adaptive ICP manager 316 may perform the determination of whether or not metadata, including a progressive_frame flag, for a frame indicates that the frame is an interlaced frame. Responsive to determining that the metadata indicates that the frame is an interlaced frame, the adaptive ICP manager 316 may deinterlace the frame and enable and/or otherwise apply the ICP filter 318 to the frame before sending the frame to a video driver 320. In some embodiments, the ICP filter 318 may include a low-pass vertical chroma filter applied to one or more chroma channels of video content to conceal and/or otherwise correct visual artifacts exhibited in some interlaced video frames. Conversely, responsive to determining that the metadata indicates that the frame is a progressive frame, the adaptive ICP manager 316 may not apply and/or may disable the ICP filter 318 and send the frame directly to video driver 320. The selective ICP filter may be applied to each video frame of the decoded video data responsive to determining that the progressive_frame flag is set to false, such that the process is performed on a frame-by-frame basis.

In either case, video driver 320 may process any received video frames to ensure compatibility of the video data with a particular video output device 322. Video driver 320 may then send the processed video output to the video output device 222. For example, the video output device 322 may correspond to the display device 12 of FIG. 1.

In some embodiments, the ICP filter 318 may be provided as a hardware filter, in which the video driver 320 loads the ICP filter 318 into the video output device 222, such that the ICP filter 318 runs in the video output device 222.

Returning once more to FIG. 2, method 200 may include presenting the video data, as indicated at 216. For example, the video frames may be output and/or displayed on a display device such that a vertical chroma filter has been applied to each interlaced frame without being applied to any progressive frames. Accordingly, displayed frames may not exhibit visual artifacts associated with the interlaced chroma problem discussed in more detail above.

In some embodiments, the methods and processes described herein may be tied to a computing system of one or more computing devices. In particular, such methods and processes may be implemented as a computer-application program or service, an application-programming interface (API), a library, and/or other computer-program product.

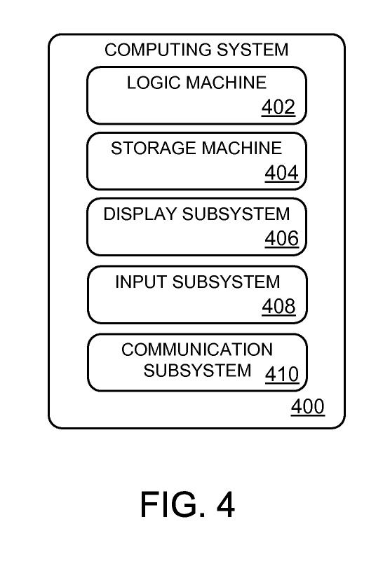

FIG. 4 schematically shows a non-limiting embodiment of a computing system 400 that can enact one or more of the methods and processes described above. Computing system 400 is shown in simplified form. Computing system 400 may take the form of one or more control devices, gaming consoles, personal computers, server computers, tablet computers, home-entertainment computers, network computing devices, mobile computing devices, mobile communication devices (e.g., smart phone), and/or other computing devices. For example, computing system 400 may include computing device 10 and/or remote computing device 16 of FIG. 1.

Computing system 400 includes a logic machine 402 and a storage machine 404. Computing system 400 may optionally include a display subsystem 406, input subsystem 408, communication subsystem 410, and/or other components not shown in FIG. 4.

Logic machine 402 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 404 includes one or more physical devices configured to hold instructions executable by the logic machine to implement the methods and processes described herein. For example, logic machine 402 may be in operative communication with storage machine 404. When such methods and processes are implemented, the state of storage machine 404 may be transformed—e.g., to hold different data.

Storage machine 404 may include removable and/or built-in devices. Storage machine 404 may include optical memory (e.g., CD, DVD, HD-DVD, Blu-ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 404 may include machine-readable volatile, nonvolatile, dynamic, static, read/write, read-only, random-access, sequential-access, location-addressable, file-addressable, and/or content-addressable devices.

It will be appreciated that storage machine 404 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 402 and storage machine 404 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 406 may be used to present a visual representation of data held by storage machine 404. This visual representation may take the form of a graphical user interface (GUI). As the herein described methods and processes change the data held by the storage machine, and thus transform the state of the storage machine, the state of display subsystem 406 may likewise be transformed to visually represent changes in the underlying data. Display subsystem 406 may include one or more display devices utilizing virtually any type of technology. Such display devices may be combined with logic machine 402 and/or storage machine 404 in a shared enclosure, or such display devices may be peripheral display devices. For example, display subsystem 406 may include display device 12 of FIG. 1.

When included, input subsystem 408 may comprise or interface with one or more user-input devices such as a keyboard, mouse, touch screen, microphone, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 410 may be configured to communicatively couple computing system 400 with one or more other computing devices. Communication subsystem 410 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 400 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. In a computing device, a method of correcting artifacts in compressed video having interlaced frames, the method comprising:
receiving decoded video data, the decoded video data including a frame and metadata corresponding to the frame; and
applying a vertical chroma filter to the frame responsive to determining that the metadata indicates that the frame is an interlaced frame.

2. The method of claim 1, wherein the metadata includes a progressive_frame flag and determining that the metadata indicates that the frame is an interlaced frame includes determining that the progressive_frame flag is set to false.

3. The method of claim 1, wherein the decoded video data is received from a decoder of the computing device, the decoder being configured to decode encoded video data including a plurality of frames and metadata corresponding to the plurality of frames.

4. The method of claim 3, further comprising selectively applying the vertical chroma filter to each of the plurality of frames.

5. The method of claim 1, further comprising outputting the decoded video data without applying the vertical chroma filter to the frame responsive to determining that the metadata indicates that the frame is a progressive_frame.

6. The method of claim 5, wherein the metadata includes a progressive_frame flag and determining that the metadata indicates that the frame is a progressive_frame includes determining that the progressive_frame flag is set to true.

7. The method of claim 1, further comprising outputting the frame to a display device.

8. The method of claim 1, wherein the vertical chroma filter is a low-pass filter applied to the frame after the decoded video data is deinterlaced.

9. A computing device comprising:
an input device for receiving an encoded stream of video data including metadata corresponding to a plurality of video frames;
a decoder for decoding the encoded stream of video data into decoded video content, the decoded video content including the plurality of video frames and at least a portion of the metadata corresponding to each frame of the plurality of video frames;
a selective filter configured to:
process a video frame of the plurality of video frames without a vertical chroma filter responsive to determining that the portion of the metadata associated with the video frame indicates that the video frame is a progressive frame; and
process the video frame with the vertical chroma filter responsive to determining that the portion of the metadata associated with the video frame indicates that the video frame is an interlaced frame.

10. The computing device of claim 9, wherein determining that the portion of the metadata associated with the video frame indicates that the video frame is a progressive frame further comprises determining that a progressive_frame flag of the portion of the metadata associated with the video frame is set to true.

11. The computing device of claim 9, wherein determining that the portion of the metadata associated with the video frame indicates that the video frame is an interlaced frame further comprises determining that a progressive_frame flag of the portion of the metadata associated with the video frame is set to false.

12. The computing device of claim 9, further comprising an output device for outputting each frame as processed by the selective filter.

13. The computing device of claim 9, further comprising deinterlacing the decoded video data before processing the video frame with the vertical chroma filter.

14. The computing device of claim 9, wherein the encoded stream of video data is encoded using 4:2:0 chroma subsampling.

15. A method of selectively applying a low-pass filter to one or more chroma channels of video content, the method comprising:
receiving encoded video data including a plurality of progressive_frame flags each corresponding to a different video frame of a plurality of video frames;
decoding the encoded video data into decoded video data, a correspondence between the plurality of progressive_frame flags and the plurality of video frames being maintained in the decoded video data and each progressive_frame flag being set to true when a corresponding video frame is a progressive frame;
applying a vertical chroma filter to a video frame of the decoded video data responsive to determining that the progressive_frame flag is set to false.

16. The method of claim 15, further comprising sending the decoded video content to an adaptive Interlaced Chroma Problem manager of a video rendering module.

17. The method of claim 15, further comprising outputting the video data to a video output device.

18. The method of claim 15, wherein the vertical chroma filter is a low-pass filter that is applied to the frame after the decoded video data is deinterlaced.

19. The method of claim 15, wherein determining that the progressive_frame flag is set to false is performed on a frame-by-frame basis.

20. The method of claim 15, wherein the encoded video data is encoded using 4:2:0 chroma subsampling.
